(19) United States
(12) Patent Application Publication
(10) Pub. No.: US 2026/0181022 A1
(43) Pub. Date: Jun. 25, 2026

(54) CLOUD DYNAMIC ENDPOINT GROUP

(71) Applicant: Palo Alto Networks, Inc., Santa Clara, CA (US)

(72) Inventors: Pratistha Srivastav, Newark, CA (US); Sivasekharan Rajasekaran, Fremont, CA (US); Nithin Varam, Dublin, CA (US)

(21) Appl. No.: 18/989,322

(22) Filed: Dec. 20, 2024

(51) Int. Cl. H04L 9/40

(52) U.S. Cl. CPC H04L 63/20; H04L 63/104; H04L 63/1433

(57) ABSTRACT

The present application discloses a method, system, and computer system for managing endpoint security and protecting a network based on a security posture. The method includes: (a) receiving a set of risk signals for each of a plurality of endpoints, wherein the set of risk signals is received from one or more trusted sources, (b) dynamically creating an endpoint group based at least in part on a risk criteria and the set of risk signals, and (c) applying security policy controls to the endpoint group consistently across access through a cloud security service and gateway firewalls.

### BACKGROUND OF THE INVENTION

In today's interconnected digital landscape, endpoints, including user devices, applications, and servers, are continually exposed to evolving security threats. Traditional security measures often rely on static classifications and predefined policies that do not account for the dynamic nature of security risks. These conventional systems lack the adaptability to respond to real-time changes in an endpoint's security posture, leaving networks vulnerable to sophisticated cyber-attacks.

### BRIEF DESCRIPTION OF THE DRAWINGS

Various embodiments of the invention are disclosed in the following detailed description and the accompanying drawings.

FIG. 1 is a block diagram of an environment for dynamically grouping endpoints based on corresponding risk postures according to various embodiments.

FIG. 2 is a block diagram of a system for enforcing a security policy with respect to an endpoint based at least in part on a set of risk signals for the endpoint and a grouping definition according to various embodiments.

FIG. 3 is an example of a user interface for defining a group definition according to various embodiments.

FIG. 4 is a flow diagram of a method for applying security policy controls for an endpoint based on the endpoint security posture according to various embodiments.

FIG. 5 is a flow diagram of a method for obtaining a normalization configuration for normalizing a particular risk signal according to various embodiments.

FIG. 6 is a flow diagram of a method for obtaining a grouping definition for use in connection with grouping endpoints according to various embodiments.

FIG. 7 is a flow diagram of a method for grouping endpoints based on a set of risk signals according to various embodiments.

FIG. 8 is a flow diagram of a method for enforcing a security policy for an endpoint according to various embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

As used herein, a security entity may be a network node (e.g., a device) that enforces one or more security policies with respect to information such as network traffic, files, etc. As an example, a security entity may be a firewall such as a next generation firewall. As another example, a security entity may be implemented as a router, a switch, a DNS resolver, a computer, a tablet, a laptop, a smartphone, etc. Various other devices may be implemented as a security entity. As another example, a security entity may be implemented as an application running on a device, such as an anti-malware application, a managed device application, a virtual private network (VPN) agent, etc.. According to various embodiments, the security entity can be physical or virtual.

As used herein, an endpoint may refer to any device, system, or application that connects to a network and interacts with other network resources or services. Endpoints are the primary subjects of the dynamic classification and risk assessment processes described in the invention. Examples of endpoints include a wide range of devices such as laptops, desktops, client terminals, mobile phones, tablets, servers, Internet of Things (IoT) devices, and applications.

According to various embodiments, endpoints are monitored and evaluated based on aggregated risk signals to determine their security posture and to enforce appropriate security policies. The endpoints can be monitored based on one or more products or services, such as third party services, each of which may report a risk signal. The system (e.g., a cloud security service) can aggregate the risk signals reported by the various security products or services, and determine a security posture or otherwise classify the endpoint (e.g., assign the endpoint to a risk grouping, etc.).

Endpoints are critical components within a network infrastructure because they often serve as entry points for potential security threats. They can be susceptible to various risks, such as malware infections, unauthorized access, or exploitation of vulnerabilities. By dynamically assessing the security posture of each endpoint, the system aims to identify and mitigate risks in real-time. The dynamic grouping and classification of endpoints allow the system to enforce security policies based on the specific risk level associated with each device or application. This inclusive definition may ensure that all potential vectors for security threats are monitored and managed effectively, enhancing the overall security posture of the organization.

Existing security frameworks may collect risk signals from various sources within a security stack but fail to effectively aggregate, normalize, and utilize this data to make informed security decisions. The absence of a dynamic grouping mechanism means that endpoints are often subject to uniform security policies, regardless of their individual risk levels. This one-size-fits-all approach can either over-restrict low-risk endpoints or inadequately protect high-risk ones.

Various embodiments enable the customers (e.g., administrators for an enterprise network) to automate the device risk and posture based changes in policy, in near real-time. This will empower them to ensure that risky devices are granted limited access to keep their network and enterprise assets safe. According to related art systems, customers are unable to take automated risk based dynamic adaptive actions on endpoints that are connected to an enterprise network security infrastructure (e.g., a network security that uses a cloud security service).

With growing sophistication of attacks and attack vectors, there is a growing need for customers to want to rely on risk verdicts from their endpoint detection and response (EDR) system/service, a network access control (NAC) system/service, a mobile device management (MD) system, etc. Various embodiments provide a simple way to consolidate risk signals from these security systems, and then based on that define specific access control actions.

Related art systems do not allow customers to identify and group devices with varying levels of risk. However, various embodiments enable systems (e.g., administrators of enterprise networks, etc.) to do this using both first party and third party risk scores and combine that with the device data collected by a remote access security service (e.g., such as a service provided by GlobalProtect offered by Palo Alto Networks), a host information profiling service (e.g., a service that provides HIP-based security policy enforcement such as based on a device type, an OS version, a status of the EDR agent, etc.).

Various embodiments provide a security system or service that can dynamically classify or group endpoints based on their determined or predicted security posture. Such a system would enable the enforcement of tailored security policies that adapt to the changing risk landscape, thereby enhancing the overall security and efficiency of network operations.

Various embodiments provide a method, system, and computer system for managing endpoint security and protecting a network based on a security posture. The method includes: (a) receiving a set of risk signals for each of a plurality of endpoints, wherein the set of risk signals is received from one or more trusted sources, (b) dynamically creating an endpoint group based at least in part on a risk criteria and the set of risk signals, and (c) applying security policy controls to the endpoint group consistently across access through a cloud security service and gateway firewalls.

Various embodiments provide a system and method for dynamically classifying or grouping endpoints based on determined or predicted security postures. The system or service can be implemented as a security service, such as a cloud-based security platform, that continuously receives a set of risk signals from various security services or products within a security stack. These risk signals can encompass user risk signals, device risk signals, and application risk signals.

In some embodiments, the system aggregates these risk signals for each endpoint, normalizing the data according to predefined risk signal normalization criteria. This normalization allows for consistent interpretation of diverse risk signals, facilitating accurate assessment of each endpoint's security posture. The aggregation process may follow a predefined risk signal aggregation scheme, enabling the system to compute a composite risk score or classification for each endpoint.

Based on the aggregated and normalized risk signals, the system can classify endpoints into dynamic groups that reflect their current security posture. These groupings can be continuously updated as new risk signals are collected, ensuring that the classification remains relevant over time. The system can classify an endpoint as belonging to a particular group based on a corresponding grouping criteria. For example, each group can have an associated predefined grouping criteria according to which the system can determine whether to group an endpoint in to a group. Administrators can define grouping criteria for one or more groups via a user interface provided by the system. Each group may correspond to different levels of risk and can be associated with specific security policies to be enforced. For example, the system (e.g., a cloud security service, or a firewall or other security that receives an indication of a grouping) stores a mapping of groupings to security policies.

Security policies linked to these dynamic endpoint groups may include one or more enforcement actions designed to mitigate risk. Examples of enforcement actions include:
Quarantine: isolating the endpoint from the network to prevent potential spread of threats.
Block: denying access to certain resources or services.
Limit Access: restricting the endpoint's permissions or network reach.
Revoke Sessions: terminating active sessions to prevent unauthorized access.
Force Multi-Factor Authentication: requiring additional authentication steps for access.
Invoke Remote Browser Isolation: redirecting browser activity through a secure, isolated environment.
Invoke Safe Web Browser (e.g., Prisma Access Browser offered by Palo Alto Networks): enforcing a secure, controlled browsing session for specific applications.

According to various embodiments, because the endpoint groupings are dynamically updated based on real-time risk assessments, the enforcement of security policies is likewise dynamically adjusted. This ensures that security measures remain proportionate to the actual risk posed by each endpoint, enhancing the effectiveness of the network's defense mechanisms.

The invention offers a significant advancement over traditional static security systems by introducing a dynamic, risk-based approach to endpoint classification and policy enforcement. It provides a scalable solution that adapts to the evolving security landscape, thereby improving the resilience and security of modern computing environments.

The system, method, service, etc. according to various embodiments offers several significant advantages that enhance the overall security and efficiency of network operations. By dynamically classifying endpoints based on real-time risk assessments, the system effectively minimizes the network's attack surface. High-risk endpoints are identified and subjected to stricter security policies, such as quarantine or limited access, reducing their exposure to critical network resources. This targeted approach ensures that vulnerable or compromised devices have minimal opportunities to be exploited by malicious actors, thereby decreasing the potential entry points for cyber-attacks.

The continuous aggregation and analysis of risk signals enable the system to maintain an up-to-date understanding of each endpoint's security posture. By proactively adjusting security policies based on the latest risk assessments, the system can prevent device risks associated with emerging threats. For instance, if an endpoint exhibits behavior indicative of a potential attack, such as unusual network activity or failed login attempts, the system can immediately enforce appropriate security measures. This real-time responsiveness helps in thwarting attacks before they can compromise the network.

Furthermore, the system reduces operational complexity by automating the classification and policy enforcement processes through dynamic grouping and real-time risk assessment. Administrators can define grouping criteria and associated security policies via a user-friendly interface, after which the system autonomously manages the classifications and policy implementations. This automation reduces the need for constant manual oversight, allowing IT personnel to focus on strategic initiatives rather than routine security management tasks.

In addition, the system's cloud-based architecture and dynamic grouping mechanism offer high scalability, accommodating growing numbers of endpoints without a decline in performance. The flexible design allows for easy integration with various security services and products within the existing security stack. Organizations can customize risk signal normalization and aggregation schemes to align with their specific security requirements, making the system adaptable to different operational contexts.

Moreover, by associating specific security policies with dynamically updated endpoint groups, the system ensures that enforcement actions are always aligned with the current risk level of each endpoint. This targeted policy application enhances the effectiveness of security measures, ensuring that high-risk endpoints receive the necessary attention while low-risk endpoints are not unnecessarily restricted. The ability to enforce actions such as multi-factor authentication or remote browser isolation precisely when needed increases the overall resilience of the network.

Various embodiments may provide immediate implementation of enforcement actions based on dynamic classifications, thereby allowing for real-time risk mitigation. As soon as an endpoint's risk level changes, the system can correspondingly adjust the security policies. This rapid response capability is crucial in preventing the lateral movement of threats within the network and in containing potential breaches swiftly.

Additionally, aggregating and normalizing risk signals from multiple sources provides administrators with comprehensive visibility into the security posture of all endpoints. The system's user interface enables easy monitoring and management of endpoint groups and associated policies. This holistic view facilitates informed decision-making and strategic planning for future security enhancements.

The system also offers cost efficiency by automating security policy enforcement and reducing manual interventions, leading to operational cost savings. By preventing security incidents through proactive measures, it helps avoid the financial repercussions associated with data breaches, such as remediation costs, legal fees, and reputational damage.

Furthermore, the system can assist organizations in meeting regulatory compliance requirements by ensuring that security policies are consistently enforced based on the latest risk assessments. Dynamic classification and policy adjustments help maintain adherence to industry standards and legal obligations related to data protection and cybersecurity.

While enforcing stringent security measures on high-risk endpoints, the system allows low-risk endpoints to operate with minimal restrictions. This balance ensures that security does not come at the expense of user productivity or experience. By dynamically adjusting policies, the system can avoid unnecessary disruptions for users whose devices pose little to no risk.

### Advanced or Next Generation Firewalls

Malware is a general term commonly used to refer to malicious software (e.g., including a variety of hostile, intrusive, and/or otherwise unwanted software). Malware can be in the form of code, scripts, active content, and/or other software. Example uses of malware include disrupting computer and/or network operations, stealing proprietary information (e.g., confidential information, such as identity, financial, and/or intellectual property related information), and/or gaining access to private/proprietary computer systems and/or computer networks. Unfortunately, as techniques are developed to help detect and mitigate malware, nefarious authors find ways to circumvent such efforts. Accordingly, there is an ongoing need for improvements to techniques for identifying and mitigating malware.

A firewall generally protects networks from unauthorized access while permitting authorized communications to pass through the firewall. A firewall is typically a device, a set of devices, or software executed on a device that provides a firewall function for network access. For example, a firewall can be integrated into operating systems of devices (e.g., computers, smart phones, or other types of network communication capable devices). A firewall can also be integrated into or executed as software applications on various types of devices or security devices, such as computer servers, gateways, network/routing devices (e.g., network routers), or data appliances (e.g., security appliances or other types of special purpose devices, and in some implementations, certain operations can be implemented in special purpose hardware, such as an ASIC or FPGA).

Firewalls typically deny or permit network transmission based on a set of rules. These sets of rules are often referred to as policies (e.g., network policies or network security policies). For example, a firewall can filter inbound traffic by applying a set of rules or policies to prevent unwanted outside traffic from reaching protected devices. A firewall can also filter outbound traffic by applying a set of rules or policies (e.g., allow, block, monitor, notify or log, and/or other actions can be specified in firewall rules or firewall policies, which can be triggered based on various criteria, such as described herein). A firewall can also filter local network (e.g., intranet) traffic by similarly applying a set of rules or policies.

Security devices (e.g., security appliances, security gateways, security services, and/or other security devices) can perform various security operations (e.g., firewall, anti-malware, intrusion prevention/detection, proxy, and/or other security functions), networking functions (e.g., routing, Quality of Service (QoS), workload balancing of network related resources, and/or other networking functions), and/or other security and/or networking related operations. For example, routing can be performed based on source information (e.g., IP address and port), destination information (e.g., IP address and port), and protocol information (e.g., layer-3 IP-based routing).

A basic packet filtering firewall filters network communication traffic by inspecting individual packets transmitted over a network (e.g., packet filtering firewalls or first generation firewalls, which are stateless packet filtering firewalls). Stateless packet filtering firewalls typically inspect the individual packets themselves and apply rules based on the inspected packets (e.g., using a combination of a packet's source and destination address information, protocol information, and a port number).

Application firewalls can also perform application layer filtering (e.g., using application layer filtering firewalls or second generation firewalls, which work on the application level of the TCP/IP stack). Application layer filtering firewalls or application firewalls can generally identify certain applications and protocols (e.g., web browsing using HyperText Transfer Protocol (HTTP), a Domain Name System (DNS) request, a file transfer using File Transfer Protocol (FTP), and various other types of applications and other protocols, such as Telnet, DHCP, TCP, UDP, and TFTP (GSS)). For example, application firewalls can block unauthorized protocols that attempt to communicate over a standard port (e.g., an unauthorized/out of policy protocol attempting to sneak through by using a non-standard port for that protocol can generally be identified using application firewalls).

Stateful firewalls can also perform stateful-based packet inspection in which each packet is examined within the context of a series of packets associated with that network transmission's flow of packets/packet flow (e.g., stateful firewalls or third generation firewalls). This firewall technique is generally referred to as a stateful packet inspection as it maintains records of all connections passing through the firewall and is able to determine whether a packet is the start of a new connection, a part of an existing connection, or is an invalid packet. For example, the state of a connection can itself be one of the criteria that triggers a rule within a policy.

Advanced or next generation firewalls can perform stateless and stateful packet filtering and application layer filtering as discussed above. Next generation firewalls can also perform additional firewall techniques. For example, certain newer firewalls sometimes referred to as advanced or next generation firewalls can also identify users and content. In particular, certain next generation firewalls are expanding the list of applications that these firewalls can automatically identify to thousands of applications. Examples of such next generation firewalls are commercially available from Palo Alto Networks, Inc. (e.g., Palo Alto Networks'PA Series firewalls).

For example, Palo Alto Networks'next generation firewalls enable enterprises to identify and control applications, users, and content-not just ports, IP addresses, and packets-using various identification technologies, such as the following: App-ID for accurate application identification, User-ID for user identification (e.g., by user or user group), and Content-ID for real-time content scanning (e.g., controls web surfing and limits data and file transfers). These identification technologies allow enterprises to securely enable application usage using business-relevant concepts, instead of following the traditional approach offered by traditional port-blocking firewalls. Also, special purpose hardware for next generation firewalls implemented, for example, as dedicated appliances generally provides higher performance levels for application inspection than software executed on general purpose hardware (e.g., such as security appliances provided by Palo Alto Networks, Inc., which utilize dedicated, function specific processing that is tightly integrated with a single-pass software engine to maximize network throughput while minimizing latency).

Advanced or next generation firewalls can also be implemented using virtualized firewalls. Examples of such next generation firewalls are commercially available from Palo Alto Networks, Inc. (e.g., Palo Alto Networks'firewalls, which support various commercial virtualized environments, including, for example, VMware® ESXi™ and NSX™, Citrix® Netscaler SDX™, KVM/OpenStack (Centos/RHEL, Ubuntu®), and Amazon Web Services (AWS)). For example, virtualized firewalls can support similar or the exact same next-generation firewall and advanced threat prevention features available in physical form factor appliances, allowing enterprises to safely enable applications flowing into, and across their private, public, and hybrid cloud computing environments. Automation features such as VM monitoring, dynamic address groups, and a REST-based API allow enterprises to proactively monitor VM changes dynamically feeding that context into security policies, thereby eliminating the policy lag that may occur when VMs change.

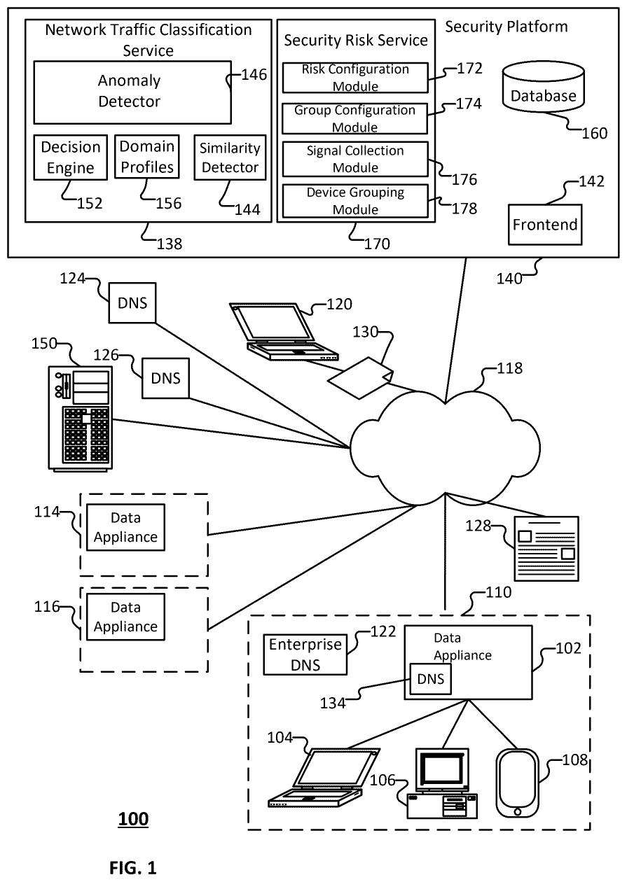

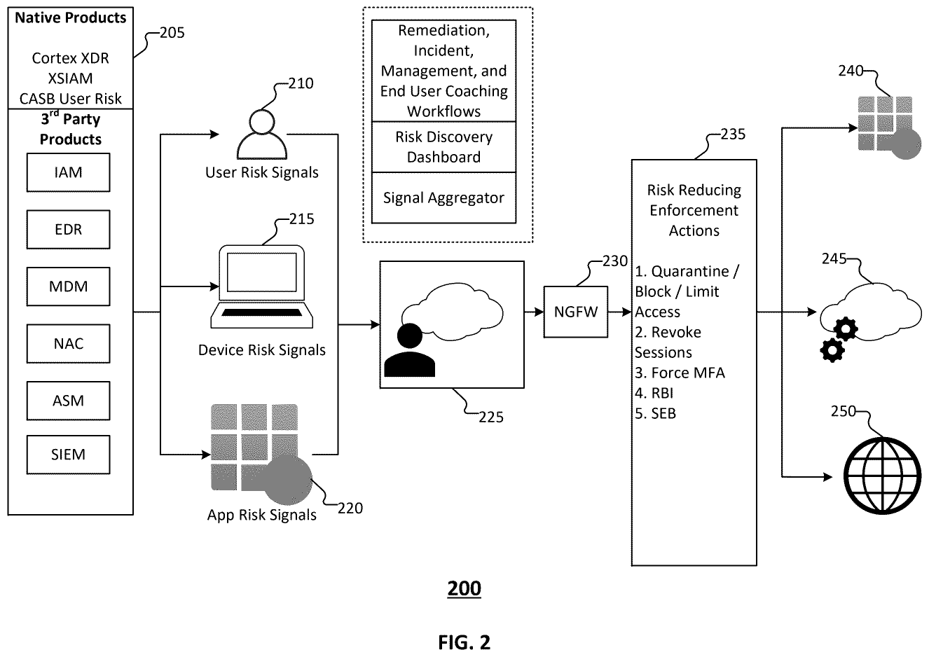

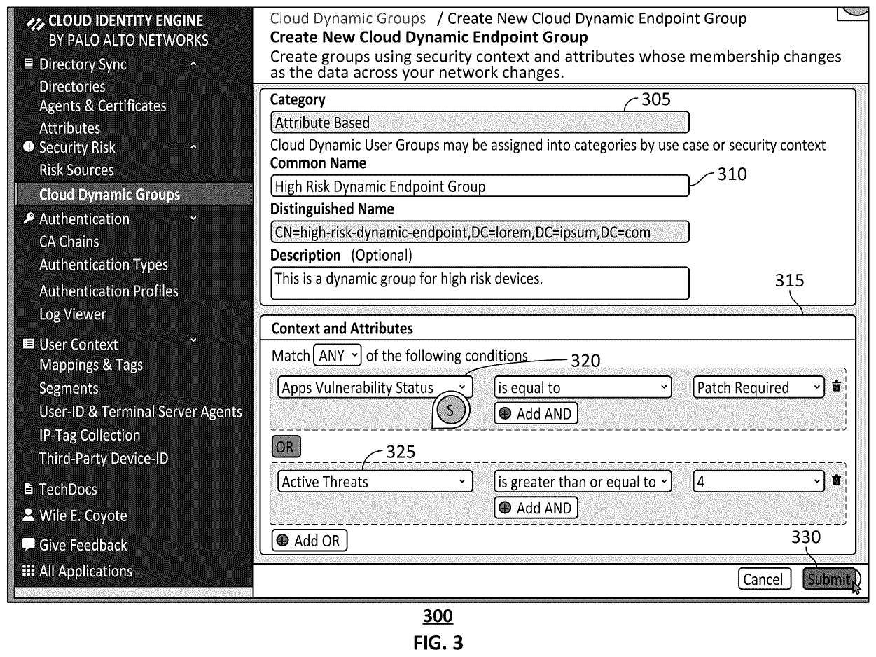

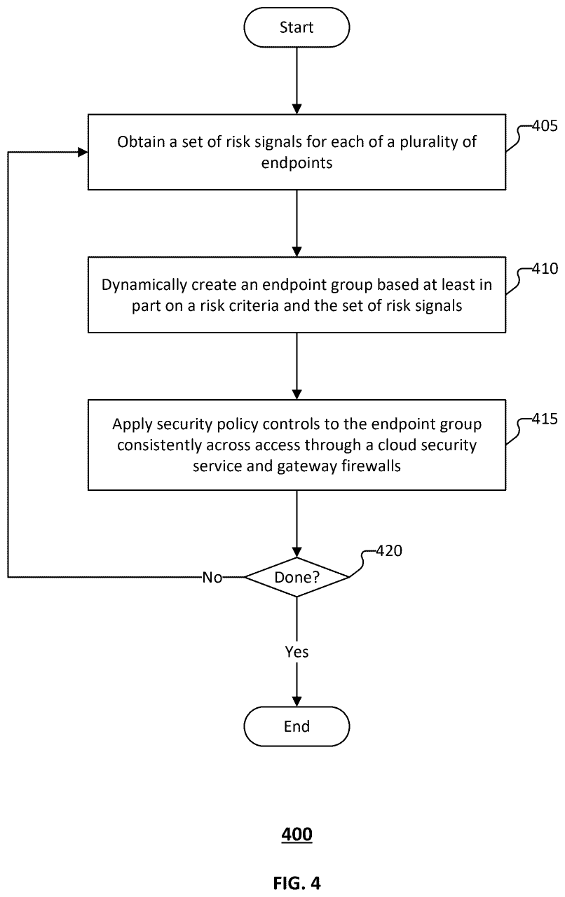

FIG. 1 is a block diagram of an environment for dynamically grouping endpoints based on corresponding risk postures according to various embodiments. In some embodiments, system 100 implements at least part of system 200 of FIG. 2, and/or user interface 300 of FIG. 3. System 100 can implement one or more of processes 400-800 of FIGS. 4-8.

In the example shown, client devices 104-108 are a laptop computer, a desktop computer, and a tablet (respectively) present in an enterprise network 110 (belonging to the “Acme Company”). Data appliance 102 is configured to enforce policies (e.g., a security policy, a network traffic handling policy, etc.) regarding communications between client devices, such as client devices 104 and 106, and nodes outside of enterprise network 110 (e.g., reachable via external network 118). Examples of such policies include policies governing traffic shaping, quality of service, and routing of traffic. Other examples of policies include security policies such as ones requiring the scanning for threats in incoming (and/or outgoing) email attachments, website content, inputs to application portals (e.g., web interfaces), files exchanged through instant messaging programs, and/or other file transfers. Other examples of policies include security policies (or other traffic monitoring policies) that selectively block traffic, such as traffic to malicious domains, DNS hijacked domains, or stockpiled domains, or such as traffic for certain applications (e.g., SaaS applications). In some embodiments, data appliance 102 is also configured to enforce policies with respect to traffic that stays within (or from coming into) enterprise network 110.

Techniques described herein can be used in conjunction with a variety of platforms (e.g., desktops, mobile devices, gaming platforms, embedded systems, etc.) and/or a variety of types of applications (e.g., Android . ask files, iOS applications, Windows PE files, Adobe Acrobat PDF files, Microsoft Windows PE installers, etc.). In the example environment shown in FIG. 1, client devices 104-108 are endpoints, such as a laptop computer, a desktop computer, and a tablet (respectively) present in an enterprise network 110. Client device 120 is a laptop computer present outside of enterprise network 110.

Data appliance 102 can be configured to work in cooperation with remote security platform 140. In some embodiments, data appliance 102 is a security entity, such as an inline firewall (e.g., a next generation firewall). Security platform 140 can provide a variety of services, including classifying domains (e.g., predicting whether a domain is a malicious domain, etc.), classifying DNS response records (e.g., predicting whether a domain IP pair in a DNS response is a DNS hijacked record, etc.), classifying network traffic, providing a mapping of signatures to certain domains or DNS records (e.g., a DNS record for which a predicted likelihood that the record is a DNS hijacked record exceeds a predefined likelihood threshold, etc. a mapping of domains or DNS records to domain or DNS record data (e.g., domain certificates, pen's data, active DNS data, WHOIS data, etc.), performing static and dynamic analysis on malware samples, monitoring new domains and new DNS records (e.g., detecting new domains for which a certificate is issued/generated), assessing maliciousness of domains, determining whether a DNS record associated with a traffic sample is (or is likely to be) a DNS hijacked record, providing a list of signatures of known exploits (e.g., malicious input strings, malicious files, malicious domains, etc.) to data appliances, such as data appliance 102 as part of a subscription, detecting exploits such as malicious input strings, malicious files, DNS hijacked records or malicious domains (e.g., an on-demand detection, or periodical-based updates to a mapping of domains or DNS records to indications of whether the domains or DNS records are malicious or benign), providing a likelihood that a domain is malicious (e.g., a DNS hijacked record) or benign (e.g., not DNS hijacked), providing/updating a whitelist of input strings, files, or domains deemed to be benign, providing/updating input strings, files, or domains deemed to be malicious, identifying malicious input strings, detecting malicious input strings, detecting malicious files, predicting whether input strings, files, DNS records, or domains are malicious, providing an indication that an input string, file, DNS record, or domain is malicious (or benign), receive risk signals (e.g., a signal pertaining to an endpoint risk for a network) from one or more other services or products, aggregate a set of risk signals (e.g., to obtain an aggregate risk score or to classify an endpoint), classify an endpoint based on a set of risk signals for the endpoint, group the endpoint into a particular group based on a determination that the set of risk signals for an endpoint matches the grouping criteria for the particular group, provide an indication (e.g., to a security entity), etc. In some embodiments, services provided by security platform 140 additionally comprise simulating DNS hijacking attacks/campaigns (e.g., generating synthetic DNS hijacked records), and/or training classifiers (e.g., training machine learning models, such as to be used to provide detection of DNS hijacked domains).

In various embodiments, results of analysis (and additional information pertaining to applications, domains, etc.), such as an analysis or classification performed by security platform 140, are stored in database 160. In various embodiments, security platform 140 comprises one or more dedicated commercially available hardware servers (e.g., having multi-core processor(s), 32G+ of RAM, gigabit network interface adaptor(s), and hard drive(s)) running typical server-class operating systems (e.g., Linux). Security platform 140 can be implemented across a scalable infrastructure comprising multiple such servers, solid state drives, and/or other applicable high-performance hardware. Security platform 140 can comprise several distributed components, including components provided by one or more third parties. For example, portions or all of security platform 140 can be implemented using the Amazon Elastic Compute Cloud (EC2) and/or Amazon Simple Storage Service (S3). Further, as with data appliance 102, whenever security platform 140 is referred to as performing a task, such as storing data or processing data, it is to be understood that a sub-component or multiple sub-components of security platform 140 (whether individually or in cooperation with third party components) may cooperate to perform that task. As one example, security platform 140 can optionally perform static/dynamic analysis in cooperation with one or more virtual machine (VM) servers. An example of a virtual machine server is a physical machine comprising commercially available server-class hardware (e.g., a multi-core processor, 32+ Gigabytes of RAM, and one or more Gigabit network interface adapters) that runs commercially available virtualization software, such as VMware Six, Citrix eServer, or Microsoft Hyper-V. In some embodiments, the virtual machine server is omitted. Further, a virtual machine server may be under the control of the same entity that administers security platform 140 but may also be provided by a third party. As one example, the virtual machine server can rely on EC2, with the remaining portions of security platform 140 provided by dedicated hardware owned by and under the control of the operator of security platform 140.

According to various embodiments, security platform 140 comprises Network traffic classification service 138 and/or security risk service 170. Security platform 140 may include various other services/modules, such as a malicious file detector, a malicious traffic detector, a parked domain detector, a DNS hijacked domain or DNS record detector, a DNS traffic classifier, an application classifier or other traffic classifier, etc. In some embodiments, security platform 140 can be implemented across a public cloud. Network traffic classification service 138 is used in connection with analyzing network traffic (e.g., websites, domains, sample files, etc. pertaining to the network traffic) and/or automatically detecting malicious network traffic. Security risk service 170 is used in connection with determining a security posture for endpoints connected to a network. Security risk service 170 can obtain a set of risk signals and classify an endpoint, such as by grouping the endpoint to a particular group based on a determination that a set of risk signals for the endpoint

In some embodiments, security risk service 170 comprises one or more of risk configuration module 172, group configuration module 174, signal collection module 176, and/or device grouping module 178.

Security risk service 170 uses risk configuration module 172 to configure a mechanism according to which risk signals are normalized, for example, to enable an aggregation of risk signals. An administrator can define via a user interface provided by system 100 the manner by which a risk signal is to be normalized or converted to a particular schema, etc. As an illustrative example, each risk signal can have a corresponding defined schema (e.g., a protocol, process, formula, etc.).

Security risk service 170 uses group configuration module 174 to define a grouping criteria according to which endpoints are to be grouped. The grouping criteria can be a set of criteria or rules that are used to indicate whether an endpoint is to be deemed to belong to the corresponding group. For example, security risk service 170 obtains a set of risk signals for an endpoint, and determines, based at least in part on the set of risk signals and a grouping criteria for a particular group, whether the endpoint belongs to (or is to be classified according to) the particular group

Group configuration module 174 can configure and provide a user interface via which a grouping criteria for a group can be defined. An example of such a user interface is illustrated in FIG. 3. An administrator can define a grouping criteria using the user interface provided by security platform 140 (e.g., security risk service 170), which can be designed to be intuitive and user-friendly. Through this interface, the administrator can specify the conditions and parameters that determine how endpoints are classified into different groups based on their risk levels (e.g., based on their corresponding risk signals). These grouping criteria are formulated by selecting from various risk signals collected by the system, such as user behavior analytics, device health status, application vulnerabilities, network activity patterns, and compliance with security policies. By configuring thresholds and rules for these risk signals, the administrator creates dynamic grouping conditions that automatically adjust as the endpoints' security postures change over time.

For instance, the administrator might set up a grouping criterion where any endpoint that fails to update its antivirus software within a specified period is classified into a higher-risk group. Alternatively, endpoints exhibiting unusual network activity, such as multiple failed login attempts or connections to suspicious domains, could be grouped together for immediate attention. The flexibility of the interface allows the administrator to tailor these criteria to the organization's specific security policies and risk tolerance levels. This dynamic grouping ensures that security measures are appropriately enforced, providing a proactive approach to threat management by adapting in real-time to the evolving security landscape.

Security risk service 170 uses signal collection module 176 to collect a set of risk signals for each endpoint by integrating with various security services and products (e.g., a set of service or products within an organization's security infrastructure). For a particular endpoint, signal collection module 176 can continuously gather data from sources such as antivirus software, intrusion detection systems, endpoint detection and response tools, network monitoring solutions, and user behavior analytics. These sources provide risk signals that may include malware detection events, vulnerability scan results, unusual network activity, authentication failures, policy compliance statuses, and other indicators of potential security issues.

Signal collection module 176 can be integrated with various service or products that provide set of risk signals. For example, signal collection module 176 can be integrated by leveraging APIs, agents, or other integration methods. This integration can ensure that signal collection module 176 performs real-time or near-real-time collection of risk signals, allowing it to promptly detect changes in the endpoint's security posture. This continuous monitoring enables security risk service 170 to dynamically adjust the classification of the endpoint and enforce appropriate security policies.

Security risk service 170 uses device grouping module 178 to classify an endpoint based on a collected set of risk signals, such as by grouping endpoints according to corresponding grouping criteria or otherwise determining whether to deem the endpoint as belonging to a particular group. In response to classifying the endpoint (e.g., determining a group to which the endpoint belongs), security risk service 170 can cause one or more corresponding security policies to be enforced. As an illustrative example, causing a security policy to be enforced can include providing to one or more security entities (e.g., an inline firewall, such as a next generation firewall) an indication of the endpoint classification (e.g., an indication of the group in which the endpoint belongs).

In some embodiments, security risk service 170 aggregates and normalizes for consistent analysis. For example, security risk service 170 correlates the diverse data points to build a comprehensive risk profile for the endpoint.

Security risk service 170 (e.g., device grouping module 178) dynamically groups endpoints by continuously analyzing the aggregated risk signals collected from various security services and products within the security stack. As each endpoint's security posture is assessed in real-time, security risk service 170 (e.g., device grouping module 178) assigns it to a specific group based on predefined grouping criteria established by the administrator. These criteria might include factors such as detected vulnerabilities, compliance status, user behavior anomalies, or device health indicators. The grouping is dynamic; as the risk signals for an endpoint change over time, security risk service 170 (e.g., device grouping module 178) automatically updates its classification, ensuring that each endpoint is always associated with the appropriate risk level and corresponding security policies.

Security risk service 170 (e.g., device grouping module 178) can configure and provide a user interface, such as dashboard, via which users (e.g., enterprise network users or administrators) can view an endpoint security posture, groupings of networks, or an overall network security based on an aggregation of endpoint security postures for endpoints connected to the network. On the user interface, the endpoint classifications and groupings can be presented in an organized and intuitive manner. Administrators can access a dashboard that displays the different endpoint groups, such as along with summary statistics such as the number of endpoints in each group and their overall risk levels. The interface may use visual cues like color coding or icons to represent different risk categories, making it easier (e.g., to emphatically display) to quickly assess the security posture across all groups. By selecting a specific group, administrators can view detailed information about the endpoints within it, including individual risk scores, recent activity, and any enforcement actions applied. This interactive display allows administrators to monitor the dynamic grouping of endpoints effectively, adjust grouping criteria as needed, and ensure that security policies are enforced appropriately across the network.

According to various embodiments, when a security entity such as a firewall or gateway receives the classification or group assignment of an endpoint from the cloud security service, it uses this information to enforce the corresponding security policies associated with that classification. The cloud security service (e.g., security platform, or security risk service 170) continuously analyzes risk signals and dynamically classifies endpoints into groups based on their security posture. This classification is communicated to the security entities within the network infrastructure. Upon receiving the classification, the security entity consults its policy database to determine the specific enforcement actions that need to be applied to endpoints in that group. For example, the security entity can query/perform a lookup against a mapping of endpoint groupings to security policies, or a mapping of endpoint classifications to security policies.

For example, if an endpoint is classified into a high-risk group due to detected vulnerabilities or suspicious behavior, the security entity may enforce stricter policies such as blocking certain network traffic, requiring multi-factor authentication, or isolating the endpoint from critical network segments. Conversely, endpoints in lower-risk groups might be granted standard access privileges with fewer restrictions. The enforcement actions are executed in real-time, ensuring that the security measures are promptly aligned with the endpoint's current risk level. This integration between the cloud security service's dynamic classification and the security entity's policy enforcement mechanisms allows for a responsive and adaptive security posture across the network.

Network traffic classification service 138 may comprise an anomaly detector 146 (e.g., configured to detect anomalies in network traffic, file samples obtained by intercepting traffic, DNS traffic, or DNS records, etc.), a decision engine 152 (e.g., configured to predict whether network traffic, intercepted file samples, DNS traffic is malicious or whether a DNS record is DNS hijacked), domain profiles 156, and/or a similarity detector 144. In some embodiments, network traffic classification service 138 detects malicious network traffic or malware obtained from intercepted network traffic (e.g., by classifying a file sample obtained by a security entity or other network node requesting a maliciousness classification).

Network traffic classification service 138 can determine the classification for network traffic (e.g., a file sample obtained from network traffic, a DNS record, a DNS query, a DNS response, etc.) based at least in part on querying a classifier(s). The classifier that is queried to provide a classification of the network traffic sample associated with the network activity is a fingerprinting-based classifier, a heuristics-based classifier, another rule-based classifier, and/or a machine-learning based classifier. The classifier may be trained based at least in part on historical samples (e.g., samples of network traffic samples extracted from network traffic). The classifier can be trained based at least in part on a machine learning process. Examples of machine learning processes that can be implemented in connection with training the classifier(s) include random forest, linear regression, support vector machine, naive Bayes, logistic regression, K-nearest neighbors (KNN), decision trees, gradient boosted decision trees, K-means clustering, hierarchical clustering, density-based spatial clustering of applications with noise (DBSCAN) clustering, principal component analysis, a neural network (NN), XGBoost, a convolutional neural network (CNN), and LLM etc. In some embodiments, the classifier implements a CNN.

According to various embodiments, security platform 140 may receive a query from a security entity (e.g., inline firewall, such as a next generation firewall) for a real-time or offline classification of a network traffic sample, such as a file.

According to various embodiments, in response to network traffic classification service 138 classifying the network traffic sample, system 100 handles the corresponding network traffic according to a predefined policy (e.g., a security policy). For example, in response to predicting that the network traffic sample corresponds to malicious network traffic, system 100 can cause the network traffic to be blocked or quarantined, etc. As another example, system 100 can cause traffic to/from a compromised host (e.g., the client system associated with the intercepted network traffic from which the malicious domain was extracted) to be quarantined or sinkholed, etc. (e.g., at least until an administrator actively configures system 100 to proceed with permitting traffic to/from the client system, such as in response to the compromised host being remediated).

According to various embodiments, in response to network traffic classification service 138 classifying the network traffic (e.g., the network traffic sample), system 100 handles the network traffic according to a predefined policy (e.g., a security policy). For example, the system queries a traffic handling policy to determine the manner by which the network traffic (e.g., network activity for a session associated with the network traffic sample) is to be handled. The traffic handling policy may be a predefined policy, such as a security policy, etc. The traffic handling policy may indicate that network traffic associated with certain domains or having certain characteristics/profiles is to be blocked and network traffic associated with other domains or having other characteristics/profiles is to be permitted to pass through the system (e.g., routed normally). The traffic handling policy may correspond to a repository of a set of policies to be enforced with respect to network traffic. In some embodiments, security platform 140 receives one or more policies, such as from an administrator or third-party service, and provides the one or more policies to various network nodes, such as endpoints, security entities (e.g., inline firewalls), etc.

In response to determining a classification for a newly analyzed network traffic sample (e.g., a newly analyzed network traffic sample for a particular session), security platform 140 (e.g., network traffic classification service 138) sends an indication that network activity (e.g., other network traffic samples) associated with the session for which the network traffic sample is obtained are associated with, or otherwise correspond to, the determined classification. In the case that the determined classification for the network traffic sample is that the corresponding network sample (e.g., a file extracted from the network traffic) or network traffic/activity is malicious network traffic/activity, security platform 140 provides an indication that network traffic/activity associated with the session for which the network traffic sample is obtained is also to be handled according to whether the network traffic sample is malicious. Security platform 140 can provide an indication that network traffic matching the network traffic sample predicted to be malicious is to be handled as a malicious network traffic. For example, security platform 140 determines (e.g., computes) a signature or identifier for the network traffic/activity (e.g., a hash or other signature, or identifier for the corresponding network session), and sends to a network node (e.g., a security entity, an endpoint such as a client device, etc.) an indication of the classification associated with the signature (e.g., an indication whether the network traffic/activity is a malicious or non-malicious). Security platform 140 may update a mapping of signatures to network traffic sample classifications and provide the updated mapping to the security entity. In some embodiments, security platform 140 further provides to the network node (e.g., security entity, client device, etc.) an indication of a manner by which network traffic/activity matching the network traffic sample or otherwise be associated with the same session as the network traffic sample classified as malicious or matching the signature is to be handled. For example, security platform 140 provides to the security entity a traffic handling policy, a security policy, or an update to a policy.

According to various embodiments, network traffic classification service 138 determines whether the network traffic sample has sufficient information with which to determine whether the network traffic activity (e.g., the network traffic associated with the session from which the network traffic sample is obtained) is malicious (e.g., to predict a maliciousness classification for the file sample or network traffic). In some embodiments, network traffic classification service 138 determines whether the network traffic sample has sufficient information with which to determine whether the network traffic activity based on a confidence associated with a maliciousness classification. For example, if the confidence for the predicted maliciousness classification is less than a predefined confidence threshold, network traffic classification service 138 can determine that the network traffic sample does not comprise sufficient information. Conversely, the confidence for the predicted maliciousness classification is greater than (or equal to or greater than) the predefined confidence threshold, network traffic classification service 138 (e.g., decision engine 152) can determine that the network traffic sample comprises sufficient information. In some embodiments, network traffic classification service 138 determines whether the network traffic sample comprises sufficient information based on one or more heuristics or other predefined rules.

In response to determining that the network traffic sample does not comprise sufficient information with which to classify the associated network traffic/activity, network traffic classification service 138 can cause the network traffic/activity associated with the network traffic sample to be monitored further. For example, network traffic classification service 138 instructs (e.g., provides an indication) to the security entity (e.g., an inline firewall) from which the network traffic sample is obtained to further monitor network traffic/activity for the corresponding session. In response to receiving an indication from network traffic classification service 138 to further monitor the network traffic/activity for the session associated with the network traffic sample, the security entity can continue to monitor the network traffic activity, identify network traffic samples, determine network traffic samples that are suspicious (e.g., detect suspicious network activity), and query security platform 140 for a further maliciousness classification.

According to various embodiments, in response to determining the maliciousness classification for a network traffic sample (e.g., obtaining the predicted maliciousness classification, such as from a classifier), network traffic classification service 138 provides an indication of the maliciousness classification, such as to the applicable security entity (e.g., the security entity that provided the network traffic sample or a security entity mediating network traffic for the session associated with the network traffic sample).

Returning to FIG. 1, suppose that a malicious individual (using client device 120) has created malware or malicious sample 130, such as a file, an input string, etc. The malicious individual hopes that a client device, such as client device 104, will execute a copy of malware or other exploit (e.g., malware or malicious sample 130), compromising the client device, and causing the client device to become a bot in a botnet. The compromised client device can then be instructed to perform tasks (e.g., cryptocurrency mining, or participating in denial-of-service attacks) and/or to report information to an external entity (e.g., associated with such tasks, exfiltrate sensitive corporate data, etc.), such as C2 server 150, as well as to receive instructions from C2 server 150, as applicable.

DNS hijacked domains, for example, can be domains that are scams, phishing sites, or sites used to distribute C2 exploits or malware.

As an illustrative example, the environment shown in FIG. 1 includes three Domain Name System (DNS) servers (122-126). As shown, DNS server 122 is under the control of ACME (for use by computing assets located within enterprise network 110), while DNS server 124 is publicly accessible (and can also be used by computing assets located within enterprise network 110 as well as other devices, such as those located within other networks (e.g., networks 114 and 116)). DNS server 126 is publicly accessible but under the control of the malicious operator of C2 server 150. Enterprise DNS server 122 is configured to resolve enterprise domain names into IP addresses, and is further configured to communicate with one or more external DNS servers (e.g., DNS servers 124 and 126) to resolve domain names as applicable.

As mentioned above, in order to connect to a legitimate domain (e.g., www. example. com depicted as website 128), a client device, such as client device 104 will need to resolve the domain to a corresponding Internet Protocol (IP) address. One way such resolution can occur is for client device 104 to forward the request to DNS server 122 and/or 124 to resolve the domain. In response to receiving a valid IP address for the requested domain name, client device 104 can connect to website 128 using the IP address. Similarly, in order to connect to malicious C2 server 150, client device 104 will need to resolve the domain, “kj32hkjqfeuo32ylhkjshdflu23.badsite.com,” to a corresponding Internet Protocol (IP) address. In this example, malicious DNS server 126 is authoritative for *.badsite.com and client device 104's request will be forwarded (for example) to DNS server 126 to resolve, ultimately allowing C2 server 150 to receive data from client device 104.

Data appliance 102 is configured to enforce policies regarding communications between client devices, such as client devices 104 and 106, and nodes outside of enterprise network 110 (e.g., reachable via external network 118). Examples of such policies include ones governing traffic shaping, quality of service, and routing of traffic. Other examples of policies include security policies such as ones requiring the scanning for threats in incoming (and/or outgoing) email attachments, website content, information input to a web interface such as a login screen, files exchanged through instant messaging programs, and/or other file transfers, and/or quarantining or deleting files or other exploits identified as being malicious (or likely malicious). In some embodiments, data appliance 102 is also configured to enforce policies with respect to traffic that stays within enterprise network 110. In some embodiments, a security policy includes an indication that network traffic (e.g., all network traffic, a particular type of network traffic, etc.) is to be classified/scanned by a classifier that implements a pre-filter model, such as in connection with detecting malicious or suspicious domains, detecting parked domains, or otherwise determining that certain detected network traffic is to be further analyzed (e.g., using a finer detection model).

In some embodiments, security platform 140 comprises a network traffic classifier that provides to a security entity, such as data appliance 102, an indication of the traffic classification. For example, in response to detecting the C2 traffic, network traffic classifier sends an indication that the domain traffic corresponds to C2 traffic to data appliance 102, and the data appliance 102 may in turn enforce one or more policies (e.g., security policies) based at least in part on the indication. The one or more security policies may include isolating/quarantining the content (e.g., webpage content) for the domain, blocking access to the domain (e.g., blocking traffic for the domain), isolating/deleting the domain access request for the domain, ensuring that the domain is not resolved, alerting or prompting the user of the client device the maliciousness of the domain prior to the user viewing the webpage, blocking traffic to or from a particular node (e.g., a compromised device, such as a device that serves as a beacon in C2 communications), etc. As another example, in response to determining the application for the domain, the network traffic classifier provides to the security entity with an update of a mapping of signatures to applications (e.g., application identifiers).

FIG. 2 is a block diagram of a system for enforcing a security policy with respect to an endpoint based at least in part on a set of risk signals for the endpoint and a grouping definition according to various embodiments. In some embodiments, system 100 implements at least part of system 200 of FIG. 2, and/or user interface 300 of FIG. 3. System 100 can implement one or more of processes 400-800 of FIGS. 4-8.

In the example shown, system 200 obtains a set of risk signals from one or more security services or products 205. In some embodiments, one or more security services or products 205 can include one or more native products/service deployed at a cloud security service and/or one or more third party products. Examples of third party products or services include one or more of: (a) an identity and access management (IAM) service, (b) an endpoint detection and response (EDR) service, (c) a mobile device management (MDM) service, (d) a network access control (NAC) service, (e) an attack surface management (ASM) service, and/or (f) a security information event management (SIEM) service.

According to various embodiments, the set of risk signals from one or more security services or products 205 includes one or more of user risk signals 210, device risk signals 215, and application risk signals 220.

According to various embodiments, user risk signals 210 may refer to indicators that assess the potential security risks associated with a user's actions, behavior patterns, or account status within a network. These signals help system 200 (e.g., the cloud security service or security risk engine that determines endpoint classifications or cloud dynamic endpoint groups) identify users who may pose a higher risk due to activities that deviate from normal patterns or violate security policies. Examples of user risk signals 210 include unusual login activities such as access from unfamiliar locations or devices, multiple failed authentication attempts, and accessing sensitive data at atypical times. Various other user signals may be implemented. Other signals might involve sudden changes in user behavior, such as downloading large volumes of data, attempting to access restricted areas of the network, or exhibiting patterns consistent with compromised credentials or insider threats.

In some embodiments, user risk signals 210 are collected through continuous monitoring of user activities across various systems and applications. System 200 can integrate with authentication services, access control mechanisms, and security monitoring tools to gather data on user logins, resource access, and behavior anomalies. Logs from identity and access management (IAM) systems, security information and event management (SIEM) solutions, and user and entity behavior analytics (UEBA) tools can provide valuable insights into user actions. By analyzing this data in real-time, system 200 (e.g., the cloud security service or security risk engine that determines endpoint classifications or cloud dynamic endpoint groups) can detect deviations from established behavioral baselines and generate risk assessments for individual users. This information is then used to adjust the security policies applied to the endpoints associated with those users, enhancing the organization's overall security posture. For example, system 200 can use these user risk signals 210 in connection with determining an endpoint classification or determining a group to which the endpoint belongs.

According to various embodiments, device risk signals 215 may refer to indicators that provide information about the security posture and potential vulnerabilities of an endpoint device within a network. These signals help the system 200 (e.g., the cloud security service or security risk engine that determines endpoint classifications or cloud dynamic endpoint groups) assess the risk associated with each device by analyzing various factors that might compromise its integrity or expose it to threats. Examples of device risk signals include outdated or missing security patches, the presence of malware or suspicious applications, configuration vulnerabilities, and deviations from standard compliance policies. Various other device risk signals may be implemented. Other signals might involve abnormal device behavior, such as unexpected network communication patterns, high CPU usage indicating potential malicious activity, or unauthorized changes to system settings.

In some embodiments, device risk signals 215 are collected through continuous monitoring and integration with security tools installed on the devices or within the network infrastructure. Endpoint protection platforms (EPP), antivirus software, and endpoint detection and response (EDR) solutions provide real-time data on malware detections, system health, and security events. Network monitoring tools can capture unusual traffic patterns or attempts to communicate with known malicious domains. System 200 may also use vulnerability scanners to identify missing patches or software updates, as well as compliance management tools to check for adherence to security policies. By aggregating and analyzing this data, system 200 (e.g., the cloud security service or security risk engine that determines endpoint classifications or cloud dynamic endpoint groups) builds a comprehensive risk profile for each device, enabling it to dynamically adjust security policies and respond to potential threats promptly. For example, system 200 can use these device risk signals 215 in connection with determining an endpoint classification or determining a group to which the endpoint belongs.

According to various embodiments, application risk signals 220 may refer indicators that provide insight into the security posture and potential vulnerabilities of applications operating within an organization's network. These signals help the system 200 (e.g., the cloud security service or security risk engine that determines endpoint classifications or cloud dynamic endpoint groups) assess risks associated with applications by analyzing factors such as known software vulnerabilities, outdated versions lacking recent security patches, unusual or unauthorized behavior, and compliance with security policies. For example, an application communicating with malicious domains, exhibiting unexpected performance anomalies, or not adhering to established security protocols generates risk signals that highlight potential threats.

These application risk signals 220 are collected through continuous monitoring and integration with various security tools deployed in the network infrastructure. Vulnerability scanners and security assessment tools evaluate applications for known weaknesses and missing updates. Application performance monitoring systems detect anomalies that could indicate security issues, such as abnormal resource usage or unexpected network communications. Security information and event management (SIEM) platforms aggregate logs and events from applications to identify suspicious activities. Additionally, compliance management tools check applications against security policies to ensure they are authorized and properly configured. By aggregating and analyzing this data, system 200 (e.g., the cloud security service or security risk engine that determines endpoint classifications or cloud dynamic endpoint groups) can build a comprehensive risk profile for each application, enabling dynamic adjustments to security policies and proactive threat mitigation. For example, system 200 can use these application risk signals 220 in connection with determining an endpoint classification or determining a group to which the endpoint belongs.

In the example shown, security risk engine 225 collects the user signals (e.g., user risk signals 210, device risk signals 215, and/or application risk signals 220) and classifies endpoints based on its corresponding risk signals. For example, security risk engine 225 determines a group to which an endpoint belongs based at least in part on its corresponding risk signals. Security risk engine 225 may further determine the group to which the endpoint belongs based at least in part on a grouping criteria for the group.

In response to receiving (e.g., collecting) the set of risk signals, security risk engine 225 aggregates the risk signals. For example, security risk engine 225 can normalize the respective risk signals. Security risk engine 225 can aggregate the normalized risk signals to determine an overall risk for the endpoint (e.g., to determine an aggregated endpoint security posture).

In some embodiments, security risk engine 225 configures a user interface via which security risk engine 225 provides an indication of an endpoint security posture (e.g., an endpoint security classification) or a group in which the endpoint belongs. The user interface may provide a risk discovery dashboard.

In response to determining an endpoint classification or a grouping of endpoints, security risk engine 225 can provide (e.g., push) to one or more security entities an indication of the endpoint classification or the grouping. For example, security risk engine 225 provides the indication to an inline security entity, such as firewall 230 (e.g., a next generation firewall).

According to various embodiments, in response to receiving an indication of the endpoint classification or a grouping of endpoints, the security entity enforces one or more security policies based on the indication. For example, firewall 230 queries a mapping of groupings to security policies or a mapping of endpoint classifications to security policies to determine a security policy to enforce for the endpoint. According to various embodiments, the security entity can be physical or virtual, such as a next generation firewall or a secure access service edge service (e.g., Prisma SASE offered by Palo Alto Networks).

In the example shown, the security policies that can be enforced by a security policy may include performing one or more risk reducing enforcement actions, such as actions 235 (e.g., quarantine, block, limit access, revoke sessions, force MFA, invoke an RBI, invoke an SEB, etc.).

The security entity (e.g., firewall 230) can enforce the one or more security policies (e.g., enforce one or more of the risk reducing enforcement actions according to the security policy) with respect to one or more private applications 240, one or more SaaS applications 245 (e.g., applications accessed by the endpoint via the enterprise network, etc.), and/or internet traffic 250.

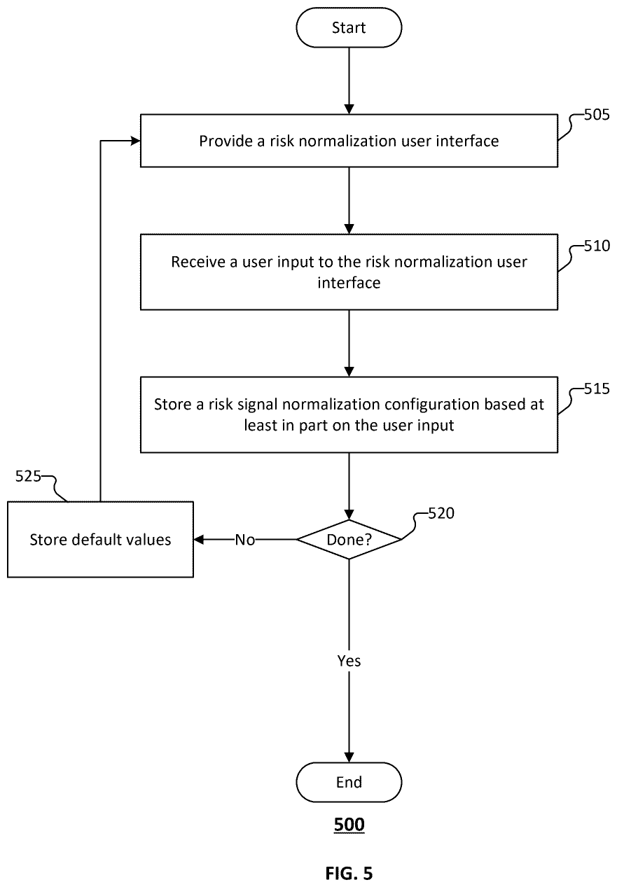

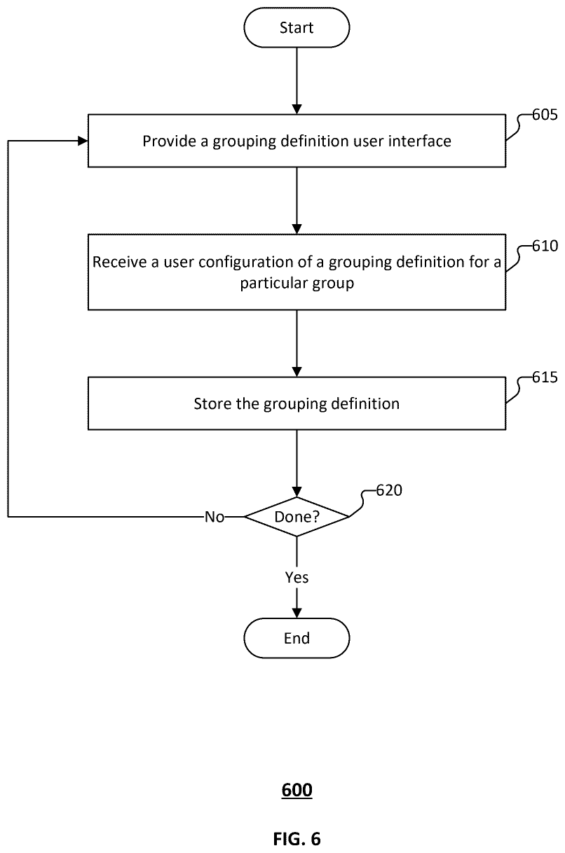

FIG. 3 is an example of a user interface for defining a group definition according to various embodiments. In some embodiments, user interface 300 is implemented by system 100 of FIG. 1 and/or system 200 of FIG. 2. User interface 300 can be implemented in connection with can implement one or more of processes 500 and/or 600 of FIGS. 5 and 6.

According to various embodiments, the system configures and provides user interface 300 in connection with enabling the definition of a group definition, such as for defining a grouping criteria for a group being configured. In the example shown, user interface 300 comprises field 305 via which a category of grouping (e.g., a cloud dynamic user group category) is defined. User interface 300 comprises field 310 via which an administrator can define a group name. User interface 300 further comprises frame 315 (e.g., a set of fields) via which the administrator can define the grouping rules or grouping criteria.

The administrator can use field 320 to define a first grouping criterion. For example, the administrator defines a characteristic, a criterion logic (e.g., is equal to, is not equal to, is less than, is greater than, etc.), and a criterion value. For example, the administrator defines a grouping criterion to indicate that if the criterion logic is satisfied based on a characteristic associated with the risk signal, a value or property of the characteristic, and the criterion value. The administrator can define the grouping criteria for a group to include a plurality of criterion. For example, the administrator can use field 325 to define a second grouping criterion. After defining the grouping criteria, the administrator can use submit button 330 to store the group definition.

FIG. 4 is a flow diagram of a method for applying security policy controls for an endpoint based on the endpoint security posture according to various embodiments. In some embodiments, process 400 is implemented at least in part by system 100 of FIG. 1 and/or system 200 of FIG. 2. Process 400 may be implemented by a system providing security service to an inline security entity, such as to a firewall (e.g., a next generation firewall).

At 405, the system obtains a set of risk signals for each of a plurality of endpoints. The set of risk signals can be provided to the system by one or more security products or services. At 410, the system dynamically creates an endpoint group based at least in part on a risk criteria and the set of risk signals. For example, the system determines, for each endpoint, the group for which the endpoint (e.g., the risk signals for the endpoint) match the group's grouping criteria. At 415, the system applies security policy controls to the endpoint group consistently across a security service (e.g., a secure access service edge service such as Prisma SASE offered by Palo Alto Networks) for access through a cloud security service and gateway firewalls. For example, the system provides an indication of the endpoint classification or an indication of the group (e.g., the endpoint group) to which the endpoint belongs to one or more security entities. The one or more security entities can enforce a security policy based on the endpoint classification or the group to which the endpoint belongs. At 420, a determination is made as to whether process 400 is complete. In some embodiments, process 400 is determined to be complete in response to a determination that no further risk signals are to be obtained, no further endpoints are to be dynamically grouped, an administrator indicates that process 400 is to be paused or stopped, etc. In response to a determination that process 400 is complete, process 400 ends. In response to a determination that process 400 is not complete, process 400 returns to 405. In some embodiments, rather than ending at process 400, process 400 can continue to assess changes (e.g., changes in the endpoints, such as endpoint security posture).

FIG. 5 is a flow diagram of a method for obtaining a normalization configuration for normalizing a particular risk signal according to various embodiments. In some embodiments, process 500 is implemented at least in part by system 100 of FIG. 1 and/or system 200 of FIG. 2. Process 500 may be implemented by a system providing security service to an inline security entity, such as to a firewall (e.g., a next generation firewall).

At 505, the system provides a risk normalization user interface. At 510, the system receives a user input to the risk normalization user interface. In some embodiments, the user input is an input received from a security service administrator. At 515, the system stores a risk signal normalization configuration based at least in part on the user input. At 520, a determination is made as to whether process 500 is complete. In some embodiments, process 500 is determined to be complete in response to a determination that no further normalization configurations/definitions are to be defined for a risk signal, an administrator indicates that process 500 is to be paused or stopped, etc. In response to a determination that process 500 is complete, process 500 ends. In response to a determination that process 500 is not complete, process 500 proceeds to 525 at which the system stores default values. A user (e.g., the administrator) can access a user interface to update a configuration of the system (e.g., a configuration or definition of a particular group, etc.). Thereafter, process returns to 505.

FIG. 6 is a flow diagram of a method for obtaining a grouping definition for use in connection with grouping endpoints according to various embodiments. In some embodiments, process 600 is implemented at least in part by system 100 of FIG. 1 and/or system 200 of FIG. 2. Process 600 may be implemented by a system providing security service to an inline security entity, such as to a firewall (e.g., a next generation firewall).

At 605, the system provides a grouping definition user interface. At 610, the system receives a user configuration of a grouping definition for a particular group. In some embodiments, the user configuration is an input received from a security service administrator. At 615, the system stores the grouping definition. At 620, a determination is made as to whether process 600 is complete. In some embodiments, process 600 is determined to be complete in response to a determination that no further groupings are to be defined, an administrator indicates that process 600 is to be paused or stopped, etc. In response to a determination that process 600 is complete, process 600 ends. In response to a determination that process 600 is not complete, process 600 returns to 605.

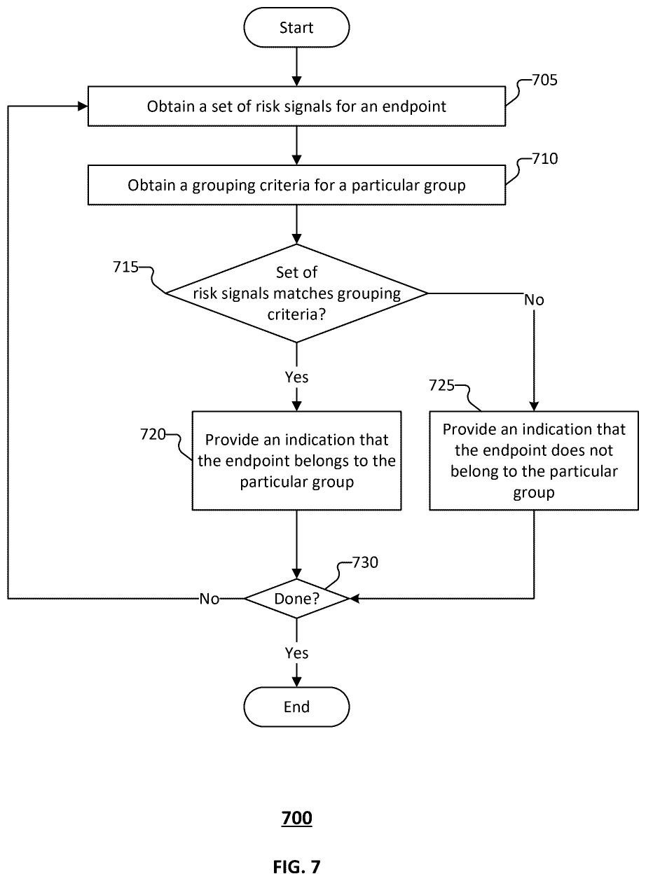

FIG. 7 is a flow diagram of a method for grouping endpoints based on a set of risk signals according to various embodiments. In some embodiments, process 700 is implemented at least in part by system 100 of FIG. 1 and/or system 200 of FIG. 2. Process 700 may be implemented by a system providing security service to an inline security entity, such as to a firewall (e.g., a next generation firewall).

At 705, the system obtains a set of risk signals for an endpoint. At 710, the system obtains a grouping criteria for a particular group. At 715, the system determines whether a set of risk signals matching a grouping criteria. In response to determining that the system determines that the set of risk signals matches the grouping criteria, process 700 proceeds to 720 at which the system provides an indication that the endpoint belongs to the particular group. In some embodiments, in response to determining that the system determines that the set of risk signals matches the grouping criteria, the system applies the appropriate security policy (e.g., a security policy associated with the group, which may include limiting access to one or more resource or service, etc.). Conversely, in response to determining that the set of risk signals does not match the grouping criteria, process 700 proceeds to 725 at which the system provides an indication that the endpoint does not belong to the particular group. At 730, a determination is made as to whether process 700 is complete. In some embodiments, process 700 is determined to be complete in response to a determination that no further endpoints are to be classified (e.g., assigned to a grouping), an administrator indicates that process 700 is to be paused or stopped, etc. In response to a determination that process 700 is complete, process 700 ends. In response to a determination that process 700 is not complete, process 700 returns to 705. In some embodiments, rather than performing 730, process 700 ends upon determination that the endpoint does not belong to the particular group.

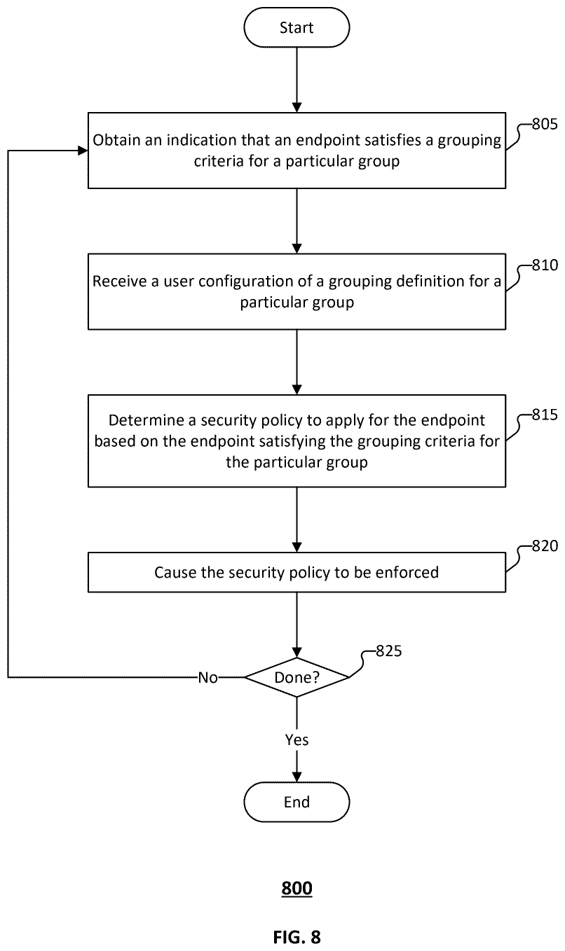

FIG. 8 is a flow diagram of a method for enforcing a security policy for an endpoint according to various embodiments. In some embodiments, process 800 is implemented at least in part by system 100 of FIG. 1 and/or system 200 of FIG. 2. Process 800 may be implemented by a system providing security service to an inline security entity, such as to a firewall (e.g., a next generation firewall).

At 805, the system obtains an indication that an endpoint satisfies a grouping criteria for a particular group. At 810, the system receives a use configuration of a grouping definition for a particular group. In some embodiments, the user configuration is an input received from a security service administrator. At 815, the system determines a security policy to apply for the endpoint based on based at least in part on the endpoint satisfying the grouping criteria for the particular group. At 820, the system causes the security policy to be enforced.

At 825, a determination is made as to whether process 800 is complete. In some embodiments, process 800 is determined to be complete in response to a determination that no further endpoints are to be classified (e.g., assigned to a grouping), no further security policies are to be enforced, an administrator indicates that process 800 is to be paused or stopped, etc. In response to a determination that process 800 is complete, process 800 ends. In response to a determination that process 800 is not complete, process 800 returns to 805.

Various examples of embodiments described herein are described in connection with flow diagrams. Although the examples may include certain steps performed in a particular order, according to various embodiments, various steps may be performed in various orders and/or various steps may be combined into a single step or in parallel.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
one or more processors configured to:
obtain a set of risk signals for each of a plurality of endpoints, wherein the set of risk signals is received from one or more trusted sources;
dynamically create an endpoint group based at least in part on a risk criteria and the set of risk signals; and
apply security policy controls to the endpoint group consistently across access through a cloud security service and gateway firewalls; and
a memory coupled to the one or more processors and configured to provide the one or more processors with instructions.

2. The system of claim 1, wherein the one or more trusted sources comprise one or more application products or services deployed in a security platform.

3. The system of claim 1, wherein at least one of the trusted sources comprises an application running on an endpoint.

4. The system of claim 1, wherein the endpoint group comprises a Cloud Dynamic Endpoint Group (CDEG).

5. The system of claim 1, wherein the risk criteria is based at least in part on a configurable logic criteria.

6. The system of claim 5, wherein the configurable logic criteria is defined by a security service administrator.

7. The system of claim 5, wherein the configurable logic criteria comprises one or more of a device attribute, a device risk, a posture detail.

8. The system of claim 1, wherein each of the plurality of endpoints is identified by a corresponding unique identifier.

9. The system of claim 8, wherein a particular unique identifier for a particular endpoint is assigned by a security platform.

10. The system of claim 1, wherein the security policy controls to the endpoint group consistently across access through the cloud security service, gateway firewalls, and a secure access service edge service.

11. The system of claim 10, wherein one or more of the gateway firewalls and the secure access service edge service are configured to provide Zero Trust Network Access (ZTNA).

12. The system of claim 1, wherein one or more of the gateway firewalls are next generation firewalls (NGFWs).

13. The system of claim 1, wherein one or more of the set of risk signals is obtained based on a periodic polling from a security platform.

14. The system of claim 1, wherein one or more of the set of risk signals is obtained based on continuously ingesting signals from security platforms that are configured to push such signals to the system.

15. The system of claim 1, wherein the one or more of the set of risk signals is obtained based at least in part on a particular trusted source determining that a predefined trusted source criteria is satisfied.

16. The system of claim 1, wherein the set of risk signals is dynamically obtained, and a set of attributes from a current set of risk signals is used in connection with updating an endpoint groupings.

17. The system of claim 1, wherein the plurality of endpoints are grouped according to a risk posture.

18. The system of claim 1, wherein:
the set of risk signals is dynamically obtained; and
dynamically creating the endpoint group comprises:
dynamically add or remove endpoints from the endpoint group based on (i) a set of attributes obtained determined based at least in part on a current set of risk signals, and (ii) a matching of the set of attributes for a particular endpoint and a corresponding set of risk criteria for a particular endpoint group.

19. The system of claim 1, wherein the one or more of:
aggregate the set of risk signals, including normalizing at least a set of risk signals to a predefined risk attribute metric.

20. The system of claim 18, wherein normalizing a set of risk signals comprises converting an attribute obtained from a risk signal to the predefined risk attribute metric according to a predefined attribute translation definition.

21. The system of claim 19, wherein the predefined attribute translation definition is customizable.

22. The system of claim 1, wherein the one or more processors are further configured to:
configure a dashboard to provide information pertaining to the endpoint group.

23. The system of claim 1, wherein the one or more processors are further configured to:
configure a dashboard via which a mapping of endpoint group definitions to corresponding risk criteria is configurable.

24. The system of claim 1, wherein a plurality of cloud dynamic groups are created based on a corresponding plurality of sets of risk criteria for applying granular security policy controls.

25. The system of claim 1, wherein a grouping of a set of endpoints is not based solely on endpoint IP addresses.

26. The system of claim 25, wherein the grouping of the end points is dynamic to ensure accurate security policy implementation as endpoint IP addresses change.

27. The system of claim 1, wherein a grouping of a set of endpoints comprises associating a set of unique identifiers corresponding to the set of endpoints with a particular CDEG.

28. The system of claim 1, wherein applying the security policy controls comprises dynamically restricting access for high-risk endpoints.

29. The system of claim 1, wherein applying the security policy controls comprises dynamically minimizing an attack surface for high-risk endpoints.

30. A method, comprising:
receiving a set of risk signals for each of a plurality of endpoints, wherein the set of risk signals is received from one or more trusted sources;
dynamically creating an endpoint group based at least in part on a risk criteria and the set of risk signals; and
applying security policy controls to the endpoint group consistently across access through a cloud security service and gateway firewalls.

31. A computer program product embodied in a non-transitory computer readable medium and comprising computer instructions for:
receiving a set of risk signals for each of a plurality of endpoints, wherein the set of risk signals is received from one or more trusted sources;
dynamically creating an endpoint group based at least in part on a risk criteria and the set of risk signals; and
applying security policy controls to the endpoint group consistently across access through a cloud security service and gateway firewalls.
